(19) United States
(12) Patent Application Publication
(10) Pub. No.: US 2024/0302531 A1
(43) Pub. Date: Sep. 12, 2024

(54) LIDAR AND CONTROL METHOD THEREOF, AND VEHICLE HAVING THE SAME

(71) Applicant: HL Klemove Corp., Incheon (KR)

(72) Inventors: Kimoon KANG, Gyeonggi-do (KR); Yunki HAN, Gyeonggi-do (KR)

(21) Appl. No.: 18/219,521

(22) Filed: Jul. 7, 2023

(30) Foreign Application Priority Data
Mar. 7, 2023 (KR) 10-2023-0029664

(51) Int. Cl. G01S 17/931; G01S 7/484; G01S 7/497; G01S 17/89

(52) U.S. Cl. CPC G01S 17/931; G01S 7/484; G01S 7/497; G01S 17/89

(57) ABSTRACT

A LiDAR and a control method thereof, and a vehicle having the same are provided. A LiDAR for a vehicle comprises a transmitter configured to generate light and transmit the light to an object; a receiver configured to receive light reflected from the object; and a signal processor configured to detect the object by processing the light received by the receiver, and perform shot accumulation to generate one frame by accumulating a plurality of shots, wherein an additional processing is performed so that a newest shot among the plurality of shots for generating one frame is reflected with the highest importance in one frame generated by accumulating the plurality of shots.

### CROSS-REFERENCE TO RELATED APPLICATION

This application claims priority to and the benefit of Korean Patent Application No. 2023-0029664, filed on Mar. 7, 2023, the disclosure of which is incorporated herein by reference in its entirety.

### BACKGROUND

### 1. Technical Field

The present disclosure generally relates to a LiDAR technology, and more particularly, to a LiDAR technology capable of reducing distortion of a moving object by compensating for a time difference between shots by weighting a newer shot with a higher importance when generating one frame from a plurality of shots.

### 2. Related Art

Recently, as a vehicle is intelligent, research on an autonomous vehicle, an advanced driver assistance system (ADAS), and the like has been actively conducted.

FIG. 1 illustrates an example of detection ranges of various sensors mounted to a vehicle.

In order to implement such an autonomous vehicle, the ADAS, and the like, various sensors are essentially required. As shown in FIG. 1, the sensors may include a radar, a LiDAR, a camera, an ultrasonic sensor, and the like. The LiDAR may have slightly lower object discrimination, but because of the advantage of accurate distance detection, the LiDAR is used by being mounted on the front and rear of most autonomous vehicles.

FIG. 2 illustrates an example of shot accumulation according to conventional art. The upper part of FIG. 2 illustrates three shots forming one frame and a histogram of a portion thereof, and the lower part of FIG. 2 illustrates a result of shot accumulation of three shots and a histogram of a portion thereof.

The LiDAR may use a shot accumulation method for measuring long-distance data. That is, referring to FIG. 2, the shot accumulation method is a method of accumulating a plurality of shots for a short time to generate one frame or the like.

However, in the conventional shot accumulation method, distortion may occur when the shots of a moving object are acquired. This is because time difference may be present between the shots even for a short time, but the time difference between the shots is not compensated. Accordingly, when a moving object is detected using the conventional LiDAR, the time difference may be present even when the shot accumulation is performed for a short time, and thus, distortion in which the same portion of the moving object is measured across several angles of view may occur.

However, the above-described description merely provides background information about the present disclosure and does not correspond to the previously disclosed technology.

### SUMMARY

In order to solve the problems of the conventional art, some of embodiments of the present disclosure provide a LiDAR technology capable of reducing distortion of a moving object by compensating for a time difference between shots by weighting a new shot with a higher importance when generating one frame from a plurality of shots.

The technical problems to be achieved in the present disclosure are not limited to the technical problems mentioned above, and other technical problems not mentioned will be clearly understood by those of ordinary skill in the art from the following description.

In order to solve the above problems, a LiDAR for external detection of a vehicle according to an embodiment of the present disclosure comprises a transmitter configured to generate light and transmit the light to an object; a receiver configured to receive light reflected from the object; and a signal processor configured to detect an object by processing light signal received by the receiver, and perform shot accumulation to generate one frame by accumulating light according to a plurality of shots, wherein an additional processing is performed so that the newest shot among the plurality of shots is reflected in the shot accumulation with the highest importance when the shot is accumulated.

The LiDAR according to an embodiment of the present disclosure may perform the additional processing so that an older shot is reflected in the shot accumulation with a lower importance when the shot is accumulated.

The transmitter may vary a power of the light related to the plurality of shots and transmits the light, and thus, a newer shot may be reflected in the shot accumulation with a higher importance.

The transmitter may transmit light corresponding to the newest shot with larger power.

The signal processor may apply various weight values for each shot when the received light signal is processed, and thus, a newer shot may be reflected in the shot accumulation with a higher importance.

The signal processor may apply a larger weight value to a newer shot in the received light.

A sum of the weight values applied to each shot is 1.

The LiDAR according to an embodiment of the present disclosure may perform the additional processing when the object is a moving object.

A LIDAR for external detection of a vehicle according to another embodiment of the present disclosure comprises a transmitter configured to generate light and transmit the light to an object; a receiver configured to receive light reflected from the object; and a signal processor configured to detect an object by processing light signal received by the receiver, and perform shot accumulation to generate one frame by accumulating light according to a plurality of shots, wherein the LiDAR performs an additional processing so that the newest shot among the plurality of shots is reflected in the shot accumulation with the highest importance when the shot is accumulated, and performs a first method in which the transmitter varies a power of the light related to the plurality of shots and transmits the light, and a second method in which the signal processor may apply various weight values for each shot when the received light signal is processed, respectively, so that a newer shot is reflected in the shot accumulation with a higher importance.

A method for controlling a LiDAR for external detection of a vehicle according to an embodiment of the present disclosure comprises: generating light and transmitting the light to an object; receiving light reflected from the object; and detecting an object by processing light signal received by the receiver, and performing shot accumulation to generate one frame by accumulating light according to a plurality of shots, wherein the newest shot among the plurality of shots is reflected in the shot accumulation with the highest importance when the shot is accumulated.

An older shot may be reflected in the shot accumulation with a lower importance when the shot is accumulated.

In the step of transmitting, the LiDAR may vary a power of the light related to the plurality of shots and transmit the light, but transmit light corresponding to the newest shot with larger power, and thus a newer shot may be reflected with a higher importance when the shot is accumulated.

In the step of performing, the LiDAR may apply various weight values for each shot when the received light signal is processed, but apply a larger weight value to a newer shot, and thus, a newer shot may be reflected in the shot accumulation with a higher importance.

The newest shot may be reflected in the shot accumulation with the highest importance when the object is a moving object.

A vehicle according to an embodiment of the present disclosure comprises a LiDAR for external detection capable of detecting an object, the LiDAR comprising: a transmitter configured to generate light and transmit the light to an object; a receiver configured to receive light reflected from the object; and a signal processor configured to detect an object by processing light signal received by the receiver, and perform shot accumulation to generate one frame by accumulating light according to a plurality of shots, wherein the newest shot among the plurality of shots is reflected in the shot accumulation with the highest importance when the shot is accumulated.

The LiDAR may be configured to detect an object located at a front side, a rear side, or a lateral side of the vehicle.

The vehicle may be an autonomous vehicle or comprise an advanced driver assistance system (ADAS).

The present disclosure configured as described above has an advantage of reducing distortion of a moving object by compensating for a time difference between shots by weighting a newer show with a higher importance when accumulating a plurality of shots for a short time to generate one frame or the like.

The effects of the present disclosure are not limited to those mentioned above, and other effects not mentioned will be clearly understood by those of ordinary skill in the art from the following description.

### BRIEF DESCRIPTION OF THE DRAWINGS

FIG. 1 illustrates an example of detection ranges of various sensors mounted to a vehicle.

FIG. 2 illustrates an example of shot accumulation according to conventional art.

FIG. 3 illustrates a configuration diagram of a LiDAR according to an exemplary embodiment of the present disclosure.

FIG. 4 is a flowchart for illustrating a method for controlling a LiDAR according to an exemplary embodiment of the present disclosure.

FIG. 5 illustrates an example of a schematic concept in which transmission pulses of a laser light are transmitted from a transmitter of LiDAR according to a first control method of the present disclosure.

FIG. 6 illustrates examples of histograms of received pulses received in a receiver of a LIDAR according to a first control method of the present disclosure and histograms of received pulses of conventional art.

FIG. 7 illustrates examples of histograms of pulses processed according to a second control method of the present disclosure and histograms of pulses processed according to conventional art.

FIG. 8 illustrates examples of a cumulative histogram of conventional art and a cumulative histogram of a second control method of the present disclosure.

FIG. 9 illustrates separate two-dimensional image frames of first to third shots and two-dimensional image frames of a cumulative shot according to conventional art and an embodiment of the present disclosure.

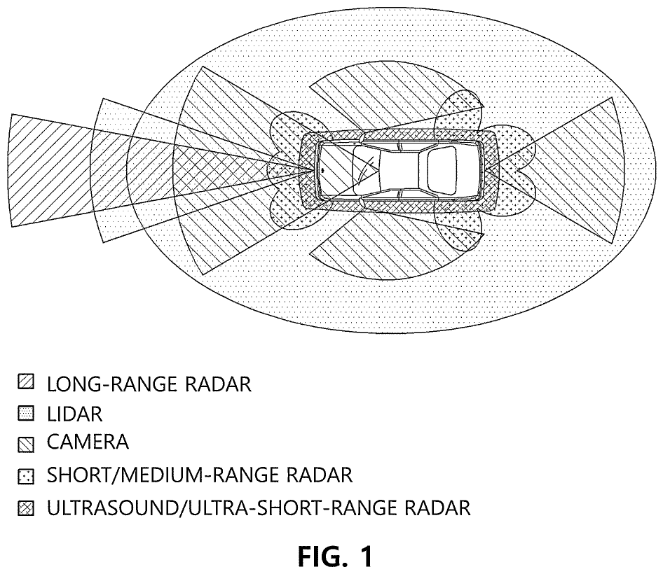

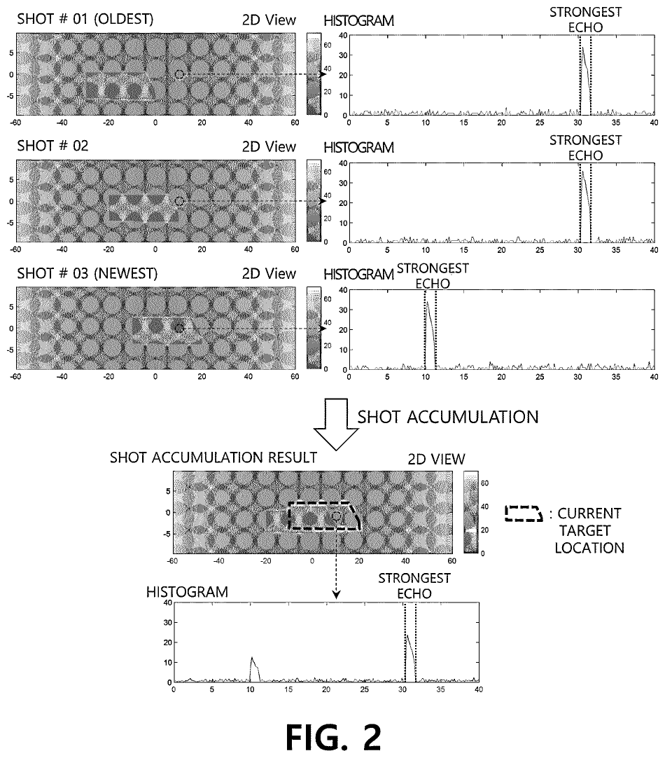

### DETAILED DESCRIPTION OF EXEMPLARY EMBODIMENTS

The above-mentioned objects, means, and effects thereof of the present disclosure will become more apparent from the following detailed description in relation to the accompanying drawings, and accordingly, those skilled in the art to which the present disclosure belongs will be able to easily practice the technical idea of the present disclosure. In addition, in describing the present disclosure, when it is determined that a detailed description of a related known technology may unnecessarily obscure the subject matter of the present disclosure, the detailed description will be omitted.

The terms used in this specification are for the purpose of describing embodiments only and are not intended to limit the present disclosure. In this specification, the singular forms “a,”, “an,” and “the” also include plural forms in some cases unless otherwise specified in the context. In this specification, terms such as “include”, “comprise”, “provide” or “have” do not exclude the presence or addition of one or more other elements other than elements mentioned.

In this specification, the terms such as “or” and “at least one” may represent one of the words listed together or a combination of two or more. For example, “A or B” and “at least one of A and B” may include only one of A or B, or may also include both A and B.

In this specification, descriptions according to “for example”, etc. may not exactly match the information presented, such as the recited properties, variables, or values, and effects such as modifications, including tolerances, measurement errors, limits of measurement accuracy, and other commonly known factors should not limit the modes for carrying out the invention according to the various exemplary embodiments of the present disclosure.

In this specification, when an element is described as being “connected” or “linked” to another element, it will be understood that it may be directly connected or linked to the other element, but intervening elements may also be present. On the other hand, when an element is referred to as being “directly connected” or “directly linked” to another element, it will be understood that there are no intervening elements present.

In this specification, when an element is described as being “on” or “adjacent to” another element, it will be understood that it may be directly “on” or “connected to” the other element, but intervening elements may also be present. On the other hand, when an element is described as being “directly on” or “directly adjacent to” another element, it will be understood that there are no intervening elements present. Other expressions describing the relationship between the elements, for example, ‘between’ and ‘directly between’, and the like can be construed similarly.

In this specification, terms such as “first” and “second” may be used to describe various elements, but, the above elements should not be limited by the terms above. In addition, the above terms should not be construed as limiting the order of each element, and may be used for the purpose of distinguishing one element from another. For example, a “first element” may be named as a “second element” and similarly, a “second element” may also be named as a “first element.”

Unless otherwise defined, all terms used in this specification may be used with meanings commonly understood by those of ordinary skill in the art to which the present disclosure belongs. In addition, terms defined in a commonly used dictionary are not interpreted ideally or excessively unless explicitly and specifically defined.

Hereinafter, a preferred embodiment according to the present disclosure will be described in detail with reference to the accompanying drawings.

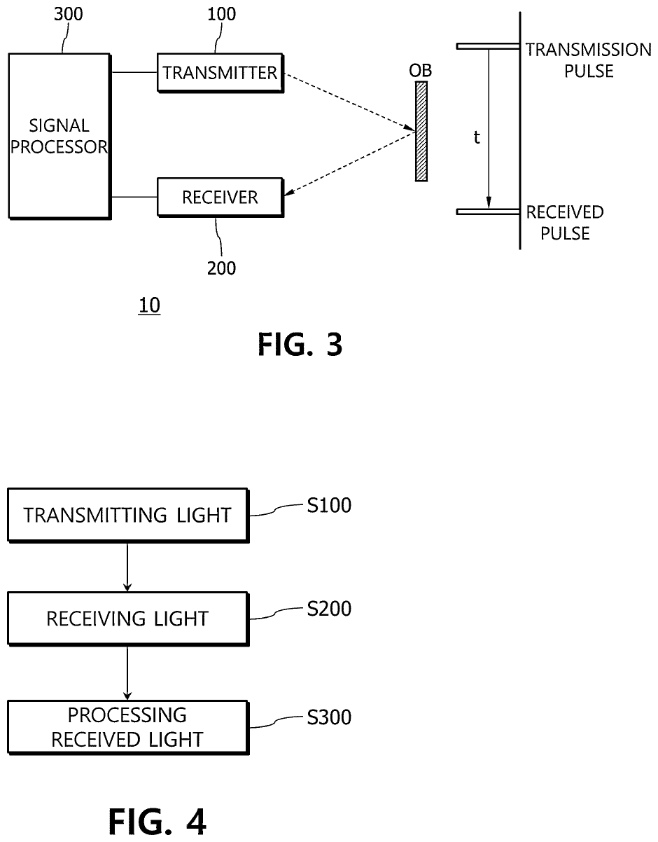

FIG. 3 illustrates a configuration diagram of a LiDAR 10 according to an exemplary embodiment of the present disclosure.

The LiDAR (Light Detection and Ranging) 10 according to an exemplary embodiment of the present disclosure may be a sensor device for detecting one or more objects such as an object around an outside of a vehicle, and may generate information on an object OB outside of the vehicle by using a laser light. In particular, the LiDAR 10 may be configured to perform a shot accumulation method of accumulating a plurality of shots for a short time period (shorter than a predetermined time) to generate one frame or the like. In this case, when the shot accumulation method is performed, the LiDAR 10 may assign a higher importance or weight to a newer shot, thereby compensating for a time difference of each shot forming one frame, and thus compensating for distortion with respect to a moving object.

In particular, when the shot accumulation method is performed, the LiDAR 10 may use a first control method of varying a power of laser light for a plurality of shots used for acquiring one frame when laser light is transmitted, or a second control method of assigning or applying various weight values to a plurality of shots, respectively, used for acquiring one frame when processing laser light reflected from the object OB. In the first control method, a laser light for newer shot may be transmitted with larger power. On the other hand, in the second control method, a larger weight value is applied or assigned to a newer shot in the received light.

The LiDAR 10 may perform either or both of the first and second control methods. Detailed description of the first and second control methods will be described later.

For example, the LiDAR 10 may be implemented as a driven or non-driven type. In the case of the driven type, the LiDAR 10 may be rotated by an actuator such as a motor, and detect the object OB around the vehicle. In the case of the non-driven type, the LiDAR 10 may detect the object OB located within a predetermined range from the vehicle by light steering, and the vehicle may include a plurality of non-driven type LiDARs.

In addition, the LiDAR 10 may detect the object OB based on a Time of Flight (TOF) method or a phase-shift method based on a laser light, and may detect a position of the detected object OB, a distance from the detected object OB, a relative speed of the detected object OB, and the like. For example, the LiDAR 10 may use an optical signal of a Frequency Modulation Continuous Wave (FMCW) scheme, but is not limited thereto.

Further, the LiDAR 10 may be placed in one or more appropriate positions of the vehicle to detect the object OB located around the vehicle, for instance, but not limited to, an object positioned in front, rear, or lateral directions of the vehicle. For example, the LiDAR 10 may be mounted to a front bumper, a radiator grill, a hood, a roof, a windshield, a door, a side mirror, a tail gate, a trunk lid, a rear bumper, a fender, or the like of a vehicle, but is not limited thereto.

The vehicle may be an autonomous vehicle or may include an advanced driver assistance system (ADAS) or the like, and may perform an autonomous driving operation or an advanced driver assistance operation by using information detected by the LiDAR 10.

Here, the ADAS may mean various types of advanced driver assistance systems or any system which is capable of assisting a driver in driving and parking functions. For example, the ADAS may include an autonomous emergency braking system, a smart parking assistance system (SPAS), a blind spot detection (BSD) system, an adaptive cruise control (ACC) system, a lane departure warning system (LDWS), a lane keeping assist system (LKAS), a lane change assist system (LCAS), or the like, but not limited thereto.

Specifically, as shown in FIG. 3, the LiDAR 10 may include a transmitter 100, a receiver 200, and a signal processor 300. In particular, the LiDAR 10 may be a LiDAR capable of detecting the object OB when a detection region is long and short distances.

Hereinafter, for convenience of description, it is assumed that the number of shots, used for acquiring one frame, n (where n is a natural number of 2 or more) is 3, but the present disclosure is not limited thereto. Of course, the following description may be applied to embodiments in which the number of shots used for acquiring one frame is 2, 4 or more than 4 (i.e. n is 2 or 4 or more).

In an exemplary embodiment in which the number of shots n used for acquiring one frame is three, three shots used for acquiring one frame may be referred to as a first shot, a second shot, and a third shot, respectively, and the first shot corresponds to the oldest or most previous shot and the third shot corresponds to the newest or most recent shot. Of course, each shot may refer to laser light transmitted from the transmitter 100 at different times, may refer to laser light transmitted from the transmitter 100 and then reflected from the object OB and received by the receiver 200 at different times, or may refer to a form (e.g., a signal) of processing, by the signal processor 300, the laser light received by the receiver 200 at different times.

In addition, the laser light related to the first shot may be referred to as “first laser light”, the laser light related to the second shot may be referred to as “second laser light”, and the laser light related to the third shot may be referred to as “third laser light”.

FIG. 4 is a flowchart for illustrating a method for controlling a LiDAR according to an exemplary embodiment of the present disclosure.

Referring to FIG. 4, the method according to an embodiment of the present disclosure may be a method for controlling driving of the LiDAR 10 described above, and may include one or more of steps S100 to S300 performed through the configuration of the transmitter 100, the receiver 200, and the signal processor 300 of FIG. 3. Steps S100 to S300 may be sequentially performed, but the present disclosure is not limited thereto. That is, the order of steps S100 to S300 may be performed in the reverse order, unlike the illustrated in FIG. 3, or at least two or more of steps S100 to S300 may be simultaneously performed.

First, in step S100, the transmitter 100 generates laser light and transmits it to an object OB. For instance, the transmitter 100 may generate laser light such as Frequency Modulation Continuous Wave (FMCW) and transmit it to the object. In this case, the transmitter 100 may include a light source module configured to generate laser light and an optical system configured to adjust a path of the laser light incident from the light source module. The optical system may include, for example, but not limited to, various lenses, mirrors, scanners, or the like.

The light source module may generate laser lights of the same wavelength or different wavelengths. For example, the light source module may generate laser light having a specific wavelength or having a wavelength variable within a wavelength range of 250 nm to 11 μm, and may be implemented through a semiconductor laser diode having a small size and a low power, but is not limited thereto.

The light source module may output the laser light by adjusting the intensity of the laser light according to the detection region. For example, when the detection region is a long distance, the light source module may output laser light having a greater intensity and, if necessary, a maximum intensity. In addition, when the detection region is a short distance, the light source unit may output laser light having a smaller intensity.

In step S200, the receiver 200 receives light reflected from the object OB. That is, the receiver 200 is a component that receives light reflected from an object. For example, the receiver 200 may convert the light reflected from the object OB into an electrical signal (such as current or the like) by using a photoelectric conversion component such as a photodiode. In this case, the reception (or measurement) angle of the receiver 200 may be referred to as a field of view (FOV). In addition, the receiver 200 may include an optical system for adjusting a path of the reflected and received light. For example, the optical system may include various lenses, mirrors, or the like, but is not limited thereto.

In step S300, the signal processor 300 processes a signal of light of the transmitter 100 and the receiver 200. That is, the signal processor 300 may include one or more processors and one or more memories. In this case, the processor may be electrically connected to the transmitter 100 and the receiver 200 to receive and process a reflected and/or received signal and generate data for the object OB based on the processed signal. In addition, the memory may store a program or executable instructions for an operation of the processor, various data, and the like, and may store a program or executable instructions related to an operation method to be described later.

For example, the memory may include a volatile memory such as a DRAM or an SRAM, and/or may include a non-volatile memory such as a PRAM, an MRAM, a ReRAM, a Read Only Memory (ROM), an Erasable Programmable Read Only Memory (EPROM), a flash memory, or the like, or may include a hard disk drive (HDD), a solid state drive (SSD), or the like, but is not limited thereto.

The signal processor 300 may determine a separation distance of the object OB or the like by collecting data according to the reflected and/or received light and processing the collected data. That is, the signal processor 300 may detect a distance, a shape, and the like of the object OB by performing signal processing on the changed data by using a time-of-flight (TOF) method, a phase-shift method, and the like.

The TOF method may be a method of measuring a separation distance of the vehicle from the object OB by measuring a time at which a pulse signal reflected from the object OB in a detection range arrives at the receiver 200 after a laser pulse signal is emitted from the transmitter 100. In addition, the phase-shift method may be a method of determining time and a separation distance by measuring an amount of change in phase of a signal reflected from an object OB in a detection range and returned to the vehicle after emitting a laser beam continuously modulated with a specific frequency from the transmitter 100.

In addition, the signal processor 300 may perform processing according to application of a shot accumulation method in addition to detecting information on the object OB such as the separation distance for a case in which a detection region is long and short distances by using the processed signal. That is, the signal processor 300 may generate one frame by accumulating a plurality of shots for a short time less than or equal to a predetermined time. When an additional control method (e.g. a second control method) to be described later is performed, the signal processor 300 applies or assigns a larger weight value to a newer shot among a plurality of shots used when acquiring one frame.

Meanwhile, when the shot accumulation method is applied, a time difference may exist or be present between shots even for a short time, but conventional technologies may not compensate for the time difference between the shots. Accordingly, when a moving object is detected using the conventional LiDAR technologies, distortion may occur in which the same portion of the moving object is measured across several angles of view due to the time difference.

To solve the problem of the conventional LiDAR, some embodiments of the present disclosure may perform the first or second control method when the shot accumulation method is applied. The first or second control method may be referred to as “additional processing”. In particular, the first or second control method may be more effectively applied when the object OB is a moving object and is located at a farther distance from the vehicle.

Hereinafter, the first and second control methods will be described in more detail.

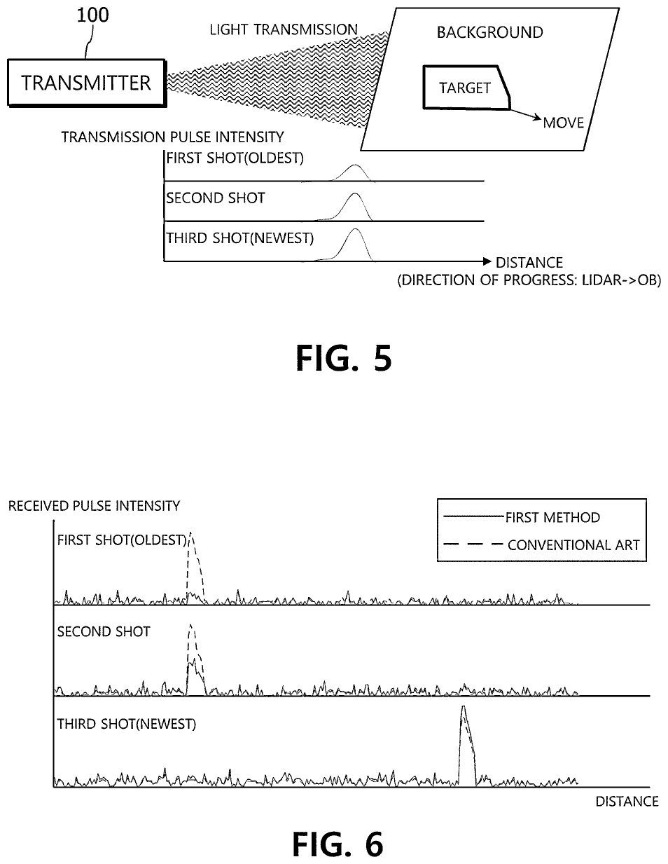

FIG. 5 illustrates examples of schematic concepts in which transmission pulses of a laser light are transmitted from the transmitter 100 according to a first control method of the present disclosure, and FIG. 6 illustrates examples of histograms of received pulses received by the receiver 200 according to the first control method of the present disclosure and histograms of received pulses of conventional art.

First, the first control method according to an embodiment of the present disclosure will be described.

Referring to FIG. 4, in the first control method according to an embodiment of the present disclosure, in operation S100, the transmitter 100 transmits laser lights to the object OB by varying the power of laser lights corresponding to a plurality of shots used for acquiring one frame. In particular, as shown in FIG. 5, the light source module of the transmitter 100 may transmit the laser light corresponding to a newer shot to the object OB at a higher or larger power among the plurality of shots forming one frame, and transmit the laser light corresponding to an older shot to the object OB at a lower or weaker power. Accordingly, the light source module of the transmitter 100 may output the second laser light at a power larger than the first laser light, and the third laser light at a power larger than the second laser light.

For example, the light source module of the transmitter 100 may vary the outputs of the first to third laser lights by differently controlling the time or duration of charging a capacitor involved in the outputs of the laser light for the first to third laser lights. That is, the light source module of the transmitter 100 may have longer capacitor charging time for a laser light corresponding to a newer shot among the plurality of shots (for instance, the capacitor charging time for the second laser light is longer than the first laser light, and the capacitor charging time for the third laser light is longer than the second laser light).

In operation S200, the receiver 200 receives light reflected from the object OB. the received light corresponding to a newer shot among the plurality of shots may be at a larger power.

Thereafter, in operation S300, the signal processor 300 processes or perform application of a shot accumulation method for generating one frame by using a plurality of shots. In this case, even if a general shot accumulation method that does not give a separate or different weight is applied to each shot, the light corresponding to a newer shot may provide a larger effect on one frame generated at operation S300.

That is, even if the general shot accumulation method is applied, power variability may be performed at the time of transmitting and receiving the laser light of each shot, so that for a newer shot closer to a current point in time, a relatively stronger signal can be received. Accordingly, an effect such as a higher weight applied to a newer shot among the plurality of shots consisting one frame may be reflected in the histogram in which each shot is accumulated. As a result, the signal processor 300 may process the second shot and the third shot to have a larger effect than the first shot and the second shot, respectively, at the time of generating one frame (i.e., at the time of generating the cumulative histogram in which the histogram for each shot is accumulated) without additional processing.

In particular, when detecting a moving object, since there is a time difference between shots even though the shot accumulation is performed for a very short time, distortion in which the same portion of the moving object is measured across several angles of view may occur. However, when the first control method is performed, as the newer shot has a larger effect in the histogram of the cumulative shot (i.e., the cumulative histogram) generated at the time of accumulating the shots, the distortion exhibited for the moving object may be reduced. That is, the first control method may correct for the distortion generated when the object OB is a moving object.

For example, referring to FIG. 5, when a target, which is a moving object, exists, the output of the laser light is variedly transmitted according to the first control method. Referring to FIG. 6, the intensity of the received laser light reflected from the object of the conventional art is illustrated as a dotted line, and the histogram of the received laser light reflected from the object according to an embodiment of the present disclosure is represented in the form of a solid line. Accordingly, the effect of increasing the weight of a shot closer to a current point in time may occur, and the distortion at the time of accumulating the shots with respect to the moving target may be reduced.

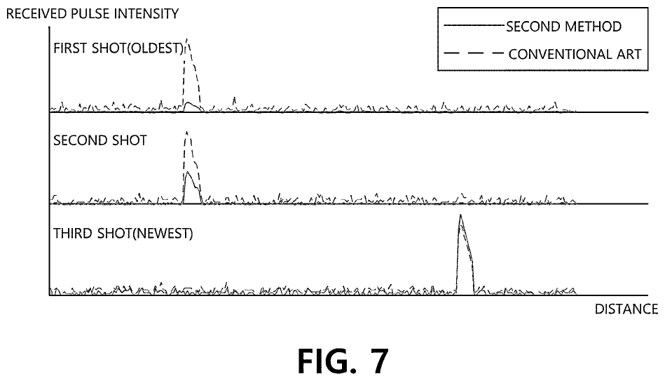

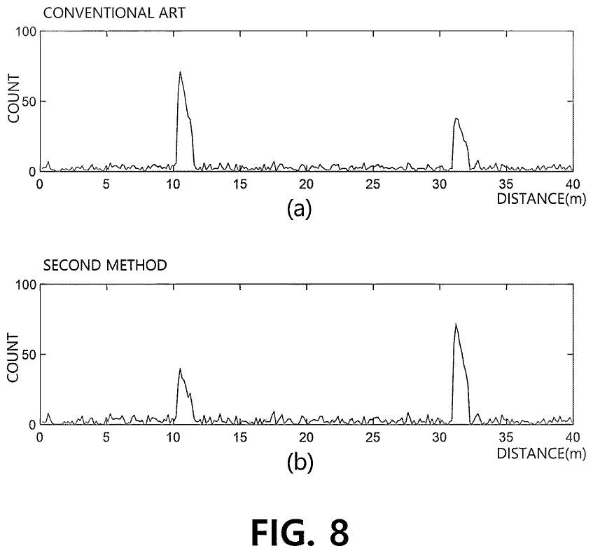

FIG. 7 illustrates examples of histograms of pulses processed according to a second control method of the present disclosure and histograms of pulses processed according to conventional art, and FIG. 8 illustrates examples of a cumulative histogram of conventional art and a cumulative histogram of the second control method of the present disclosure.

Next, the second control method according to an embodiment of the present disclosure will be described.

Unlike the first control method described above, in the second control method according to an embodiment of the present disclosure, in operation S100, the transmitter 100 transmits the laser light to the object OB in the method described above in accordance with FIG. 4. That is, the light source module of the transmitter 100 may transmit laser light corresponding to each shot to the object OB at the same level or range of power without varying the power of the laser lights corresponding to the plurality of shots used for acquiring one frame. Accordingly, the light source module of the transmitter 100 may output the first to third laser lights at the same level or range of power.

In S200, the receiver 200 receives light reflected from the object OB. However, unlike the first control method, the receiver 200 according to the second control method receives each shot having the same level or range of power.

Thereafter, in operation S300, the signal processor 300 processes application of a shot accumulation method for generating one frame by using each shot. In this case, the signal processor 300 may process to accumulate each shot by assigning giving different weights to the histogram of each shot among the plurality of shots consisting one frame.

As shown in FIG. 7, the signal processor 300 may process to assign or apply a larger weight value to a newer shot and apply a smaller weight value to an older shot for a plurality of shots used when generating one frame. For example, the signal processor 300 may assign a larger weight to the second shot than the first shot and assign a larger weight to the third shot than the second shot. Accordingly, in the histogram in which each shot is accumulated, an effect of assigning a higher weight to a newer shot occurs. As a result, the signal processor 300 may process the second shot and the third shot to have a larger effect than the first shot and the second shot, respectively, at the time of generating one frame (i.e., at the time of generating the cumulative histogram in which the histogram for each shot is accumulated).

In this case, the matrix H for the obtained histogram of each shot may be represented by Equation 1 below.

$$H = [ \begin{matrix}{h}_{1} \\ {h}_{2} \\ ⋮ \\ {h}_{n}\end{matrix} ] \qquad ( Equation 1 )$$

In Equation 1, h₁ represents a histogram of a first shot, h₂ represents a histogram of a second shot, and hₙ represents a histogram of an n^{th} shot. In this case, the n^{th} shot corresponds to the newest shot.

In addition, the vector W having a weight applied to each shot as an element may be represented by Equation 2 below.

$$w = [ {w}_{1} , {w}_{2} , … , {w}_{n} ] \qquad ( Equation 2 )$$

In Equation 2, W₁ represents a weight for a first shot, W₂ represents a weight for a second shot, and Wₙ represents a weight for an n^{th} shot. However, in order to prevent additional distortion from occurring due to these weights, it may be preferable that the sum of each weight (i.e., W₁+W₂+ . . . . Wₙ) is set to be 1. That is, each of the weights W₁, W₂, . . . . Wₙ may have a value between 0 and 1.

The signal processor 300 may generate a modified histogram for each shot by applying a weight of the vector W to the histogram of each shot. That is, the modified histogram (i.e., the cumulative histogram; h̅) may be represented by a product of the histogram of each shot and each weight as shown in Equation 3.

$$\overline{h} = wH \qquad ( Equation 3 )$$

Thereafter, the signal processor 300 may generate one frame for the cumulative shots by accumulating the plurality of shots to which weights are applied, respectively. That is, the signal processor 300 may generate the cumulative histogram by accumulating modified histograms.

In particular, when detecting a moving object, since there is a time difference between shots even though the shot accumulation is performed for a very short time, distortion in which the same portion of the moving object is measured across several angles of view may occur. However, when the second control method is performed, as the newer shot has a larger effect in the histogram of the cumulative shot (i.e., the cumulative histogram) generated at the time of accumulating the shots, the distortion exhibited for the moving object may be reduced. Accordingly, the second control method may correct for the distortion generated when the object OB is a moving object.

Referring to FIG. 7, in conventional art, a histogram having a shape such as a dotted line is generated for each shot. In conventional art, values of peak portions are similar in an old shot as well as newest shot, and a value of the peak portion in an old shot corresponds to an echo portion of the moving object. Accordingly, as shown in FIG. 8(a), when the plurality of shots are accumulated, the echo portion of the moving object in the shots stands out in the cumulative histogram. As a result, in conventional art, distortion caused by the echo portion of the moving object is generated in the cumulative histogram.

Meanwhile, referring to FIG. 7, when the second control method according to an embodiment of the present disclosure is applied, a histogram having a shape such as a solid line is generated for each shot. In this case, a value of a peak portion of an older shot corresponding to the echo portion of the moving object is considerably reduced compared to the value of the peak portion of the newer shot according to the second control method. Accordingly, as shown in FIG. 8(b), when the shots are accumulated, the echo portion of the moving object in the older shot is hardly reflected in the cumulative histogram, so that the echo portion does not stand out in the cumulative histogram, and instead, the histogram of the moving object in the newer shot is greatly reflected in the cumulative histogram and stands out. As a result, the occurrence of distortion caused by the echo portion of the moving object may be mitigated in the cumulative histogram. The results of FIG. 8 may be equally applied to the first control method.

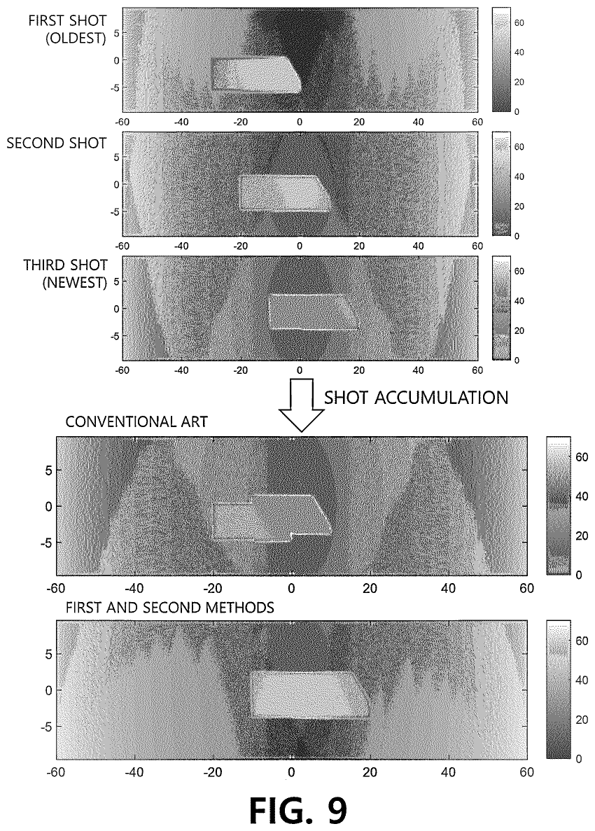

FIG. 9 illustrates separate two-dimensional image frames of first to third shots and two-dimensional image frames of a cumulative shot according to conventional art and an embodiment of the present disclosure.

When an object moving to the right is detected by using the LiDAR, as shown in the upper part of FIG. 9, the dark color portion of the pentagon corresponding to the moving object gradually moves to the right in the image frame of the shots. When the shots are accumulated according to conventional art, distortion occurs for the shape and position of the moving object in the image frame of the cumulative shot.

On the other hand, when the first and second control methods according to an embodiment of the present disclosure are applied, distortion may be mitigated for the shape and position of the moving object in the image frame of the cumulative shot. In addition, the position of the moving object in the image frame of the cumulative shot becomes similar to the position according to the newest shot. That is, by applying the first and second control methods according to the present disclosure, distortion may be improved for the shape and position of the moving object in the cumulative shot. Of course, either one or both of the first and second control methods may be used in certain embodiments of the present disclosure. In this case, distortion may be more improved for the shape and position of the moving object in the cumulative shot.

In the detailed description of the present disclosure, although specific embodiments have been described, it is apparent that various modifications are possible without departing from the scope of the present disclosure. Therefore, the scope of the present disclosure is not limited to the described embodiments, and should be defined by the following claims and their equivalents.

What is claimed is:

1. A Light Detection and Ranging (LiDAR) for a vehicle, the LiDAR comprising:
a transmitter configured to generate and transmit lights;
a receiver configured to receive lights reflected from an object; and
a signal processor configured to detect the object by processing the lights received by the receiver, and generate one frame by accumulating a plurality of shots corresponding to the lights,
wherein a newest shot among the plurality of shots for generating the one frame is weighted with a highest importance in the one frame generated by accumulating the plurality shots.

2. The LiDAR of claim 1, wherein an older shot among the plurality of shots for generating the one frame is weighted with a lower importance in the one frame generated by accumulating the plurality shots.

3. The LiDAR of claim 2, wherein the transmitter is configured to vary power of the lights for generating the plurality of shots such that a newer shot among the plurality of shots for generating the one frame is weighted with a higher importance in the one frame generated by accumulating the plurality shots.

4. The LiDAR of claim 3, wherein the transmitter is configured to transmit a light for the newer shot with larger power.

5. The LiDAR of claim 1, wherein the signal processor is configured to apply various weight values to the plurality of shots such that a newer shot among the plurality of shots for generating the one frame is weighted with a higher importance in the one frame generated by accumulating the plurality shots.

6. The LiDAR of claim 5, wherein the signal processor is configured to apply a larger weight value to the newer shot.

7. The LiDAR of claim 6, wherein a sum of the weight values applied to the plurality of shots is 1.

8. The LiDAR of claim 1, wherein, when the object is a moving object, the newest shot among the plurality of shots for generating the one frame is weighted with the highest importance in the one frame generated by accumulating the plurality shots.

9. A method for controlling a LiDAR for a vehicle, the method comprising:
generating and transmitting lights;
receiving lights reflected from an object; and
detecting the object by processing the lights received by the receiver, and generating one frame by accumulating a plurality of shots corresponding to the lights,
wherein a newest shot among the plurality of shots for generating the one frame is weighted with a highest importance in the one frame generated by accumulating the plurality shots.

10. The method of claim 9, wherein an older shot among the plurality of shots for generating the one frame is weighted with a lower importance in the one frame generated by accumulating the plurality shots.

11. The method of claim 10, wherein the generating and transmitting of the lights comprises varying power of the lights for generating the plurality of shots such that a newer shot among the plurality of shots for generating the one frame is weighted with a higher importance in the one frame generated by accumulating the plurality shots.

12. The method of claim 11, wherein the generating and transmitting of the lights comprises transmitting a light corresponding a newer shot with larger power.

13. The method of claim 9, wherein the generating of the one frame comprises applying various weight values to the plurality of shots such that a newer shot among the plurality of shots for generating the one frame is weighted with a higher importance in the one frame generated by accumulating the plurality shots.

14. The method of claim 13, wherein a larger weight value is applied to the newer shot.

15. The method of claim 14, wherein a sum of the weight values applied to the plurality of shots is 1.

16. The method of claim 9, wherein the newest shot among the plurality of shots for generating the one frame is weighted with the highest importance in the one frame generated by accumulating the plurality shots when the object is a moving object.

17. A vehicle comprising a LiDAR for detecting an object, the LiDAR comprising:
a transmitter configured to generate and transmit lights;
a receiver configured to receive lights reflected from the object; and
a signal processor configured to detect the object by processing lights received by the receiver, and generate one frame by accumulating a plurality of shots corresponding to the lights,
wherein a newest shot among the plurality of shots for generating the one frame is weighted with a highest importance in the one frame generated by accumulating the plurality shots.

18. The vehicle of claim 17, wherein the signal processor is configured to apply various weight values to the plurality of shots such that a newer shot among the plurality of shots for generating the one frame is with a higher importance in the one frame generated by accumulating the plurality shots.

19. The vehicle of claim 17, wherein the LiDAR is configured to detect the object located at a front side, a rear side, or a lateral side of the vehicle.

20. The vehicle of claim 17, wherein the vehicle is an autonomous vehicle or comprises an advanced driver assistance system (ADAS).
